(19) United States
(12) Patent Application Publication
(10) Pub. No.: US 2015/0184612 A1
(43) Pub. Date: Jul. 2, 2015

(54) PISTON FOR INTERNAL COMBUSTION ENGINE

(71) Applicant: HONDA MOTOR CO., LTD., Tokyo (JP)

(72) Inventors: Ryotaro Takada, Utsunomiya-shi (JP); Takahisa Tashiro, Sakura-shi (JP); Masahiro Yamanaka, Utsunomiya-shi (JP); Yositaka Tsujii, Utsunomiya-shi (JP); Takeshi Munemura, Haga-gun (JP)

(21) Appl. No.: 14/421,531

(22) PCT Filed: Apr. 22, 2013
(86) PCT No.: PCT/JP2013/061716

§ 371 Date: Feb. 13, 2015

(30) Foreign Application Priority Data
Aug. 27, 2012 (JP) 2012-186044

(51) Int. Cl. F02F 3/10; F02F 3/00

(52) U.S. Cl. CPC F02F 3/10; F02F 3/0084

(57) ABSTRACT

A piston that maintains excellent lubricating performance even when the internal combustion engine is operated in severe environments. A primer layer including a resinous material is disposed on the sliding surface of the skirt of a piston, and solid lubricating parts, preferably including silver (Ag), a silver alloy, copper (Cu), or a copper alloy are disposed on the primer layer. In the primer layer and the solid lubricating parts, a fibrous filler including metallic fibers, etc., is present so as to extend across the boundary between the primer layer and the solid lubricating parts.

### TECHNICAL FIELD

The present invention relates to a piston for an internal combustion engine, the piston being movable back and forth in a cylinder of the internal combustion engine.

### BACKGROUND ART

Automobiles travel by causing tires to rotate with a rotational drive force, which is converted from a drive force that is generated by an internal combustion engine supplied with a fuel. Recently, various attempts have been made to improve the fuel consumption ratio (gas mileage) of internal combustion engines on such automobiles. Since an improved fuel consumption ratio reduces the amount of fuel consumed, energy savings and protection of the global environment can be realized.

One such attempt is directed toward reducing the resistance to sliding movement between inner wall surfaces of cylinders (inner wall surfaces of bores or sleeves) of the internal combustion engine and pistons that move back and forth in the cylinders. If resistance to sliding movement is reduced, the pistons move back and forth more easily in the cylinders. Therefore, the drive force applied to move the pistons back and forth is reduced, resulting in a reduction in the amount of fuel consumed.

It is known in the art to deposit a layer including a lubricant-rich material on the inner wall surfaces of cylinders or piston skirts in order to reduce resistance to sliding movement of the pistons, for improving the lubrication properties of the inner wall surfaces of the cylinders or the piston skirts. For example, as disclosed in International Publication No. WO 2011/115152, the present applicant has proposed providing ridges on the sliding surface of a piston skirt, and covering the ridges with a lubricating film made of silver, silver alloy, copper, or copper alloy.

As disclosed in International Publication No. WO 2011/115152, it is preferable to interpose an intermediate layer made of a heat-resistant resin material between the film and the piston skirt, in order to ensure that the film is firmly bonded to the piston skirt by the intermediate layer. Specific examples of such a heat-resistant resin material include polyimide resin, polyamide-imide resin, epoxy resin, nylon-6 resin, and nylon-6,6 resin, etc.

The existence of the film on the piston of the internal combustion engine is effective to suitably maintain a lubricant between the inner wall surface of the cylinder, e.g., the inner wall surface of the sleeve, and the piston skirt. The existence of the film also serves to spread or transfer frictional heat quickly, so that the piston skirt and the inner wall surface of the cylinder can be prevented from becoming adhered to each other.

### SUMMARY OF INVENTION

Vehicles that travel in severe environments, such as racing cars or the like, which are driven at high speeds over a long period of time, are required to be powered by a highly durable internal combustion engine as compared to general vehicles. For example, the piston used in the internal combustion engine disclosed in International Publication No. WO 2011/115152 desirably makes the film less liable to come off the piston skirt insofar as possible, thereby preventing the piston skirt and the inner wall surface of the cylinder from becoming adhered to each other over a long period of time.

The present invention has been made in connection with the technology disclosed in International Publication No. WO 2011/115152. A major object of the present invention is to provide a piston for use in an internal combustion engine, which is capable of making a solid lubricator less liable to come off for thereby suitably maintaining a lubricant between a piston skirt and the inner wall surface of the piston.

Another object of the present invention is to provide a piston for use in an internal combustion engine, which is capable of preventing the inner wall surface of a cylinder and a piston skirt from becoming adhered to each other.

According to an embodiment of the present invention, there is provided a piston for use in an internal combustion engine, which is movable back and forth in a cylinder of the internal combustion engine, comprising:
a base layer disposed on a sliding contact surface of a piston skirt, the base layer containing a resin material;
a solid lubricator disposed on the base layer; and
fibrous fillers that reside within and extend between the base layer and the solid lubricator.

The fibrous fillers exist across a boundary between the base layer and the solid lubricator, such that the fibrous fillers extend from the base layer into the solid lubricator. In other words, the fibrous fillers have ends that are embedded in the solid lubricator and other ends that are embedded in the base layer. Hence, the fibrous fillers develop an anchoring effect in both the base layer and the solid lubricator. Therefore, the base layer and the solid lubricator are firmly joined to each other via the fibrous fillers. As a result, it is difficult for the solid lubricator to peel off and separate away from the base layer.

The internal combustion engine in which the piston is incorporated remains highly durable even if the internal combustion engine is used in cars that travel in severe environments, such as racing cars or the like.

Assuming that a weight of the resin material is given as 100% by weight, the proportion of the fibrous fillers lies within a range from 10% to 65% by weight. The proportion of the fibrous fillers, which is 10% or greater by weight, allows the fibrous fillers to develop a sufficient anchoring effect, thereby making it possible to sufficiently increase the bonding strength between the base layer and the solid lubricators. The proportion of the fibrous filler, which is 65% or less by weight, is effective to cause the resin material to sufficiently hold the solid lubricator on the piston skirt. Stated otherwise, the fibrous fillers, which are contained in the resin material in the above range, make it possible to prevent the solid lubricator from coming off, suitably maintain the lubricant between the inner wall surface of the cylinder and the piston skirt, and are capable of avoiding adhesion from occurring between the inner wall surface of the cylinder and the piston skirt.

The solid lubricator preferably comprises at least one of silver, silver alloy, copper, or copper alloy. Each of such materials exhibits an excellent lubricating capability when the piston skirt is held in sliding contact with the inner wall surface of the cylinder.

### BRIEF DESCRIPTION OF DRAWINGS

FIG. 1 is a perspective view showing in its entirety a piston according to an embodiment of the present invention;

FIG. 2 is a side elevational view of the piston shown in FIG. 1;

FIG. 3 is a fragmentary cross-sectional view of a surface layer region of a piston skirt of the piston;

FIG. 4 is an enlarged cross-sectional view of a boundary region between a base layer and a solid lubricator, which are deposited on a sliding contact surface in a surface layer region of the piston skirt;

FIG. 5 is a side elevational view of a piston according to another embodiment of the present invention;

FIG. 6 is an enlarged cross-sectional view of a surface layer region of a piston skirt of a piston according to yet another embodiment of the present invention;

FIG. 7 is a view showing a test piece according to an Inventive Example and the result of a peel test;

FIG. 8 is a view showing a test piece according to a Comparative Example 1 and the result of a peel test;

FIG. 9 is a view showing a test piece according to a Comparative Example 2 and the result of a peel test;

FIG. 10 is a view showing a test piece according to a Comparative Example 3 and the result of a peel test; and

FIG. 11 is a view showing a test piece according to a Comparative Example 4 and the result of a peel test.

### DESCRIPTION OF EMBODIMENTS

Pistons for use in internal combustion engines (hereinafter referred to simply as “pistons”) according to preferred embodiments of the present invention will be described in detail below with reference to the accompanying drawings.

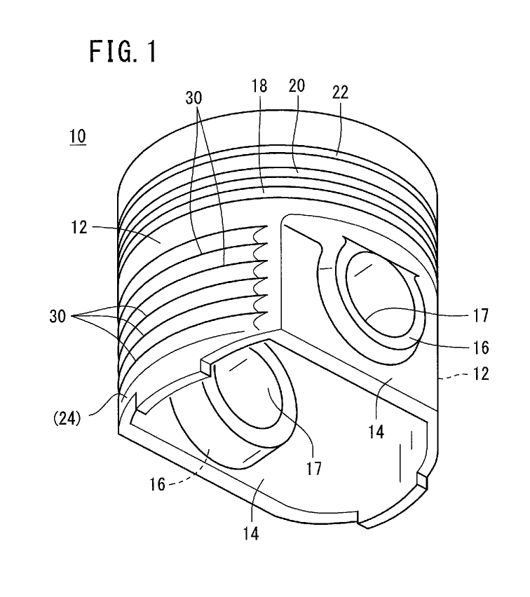

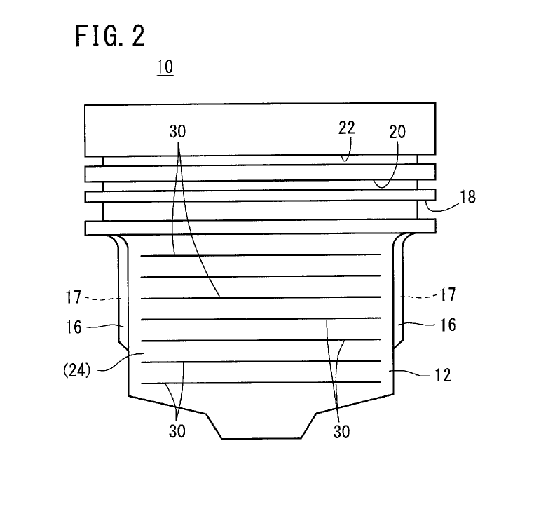

FIG. 1 is an overall perspective view showing the entirety of a piston 10 according to an embodiment of the present invention. FIG. 2 shows the piston 10 in side elevation. The piston 10 includes a pair of piston skirts 12, 12 in a lower portion thereof, and a pair of walls 14, 14, which extend substantially vertically and are disposed between the piston skirts 12, 12. The walls 14, 14 have respective pin bosses 16, 16 that project horizontally. The pin bosses 16, 16 have respective piston pin holes 17, 17 defined respectively therethrough for insertion of a non-illustrated piston pin. The piston pin extends through a penetrating hole, which is defined in a smaller end of a non-illustrated connecting rod, thereby pivotally supporting the connecting rod on the piston 10.

The piston 10 includes an oil ring groove 18, a first piston ring groove 20, and a second piston ring groove 22, which are defined above the piston skirts 12, 12 and arranged successively upward in this order. The oil ring groove 18, the first piston ring groove 20, and the second piston ring groove 22 extend circumferentially around a head portion of the piston 10.

The piston 10, which is constructed in the foregoing manner, is made of an aluminum alloy such as AC2A, AC2B, AC4B, AC4C, AC4D, AC8H, or A1100 (aluminum alloys defined according to JIS), an Al—Cu alloy, or the like.

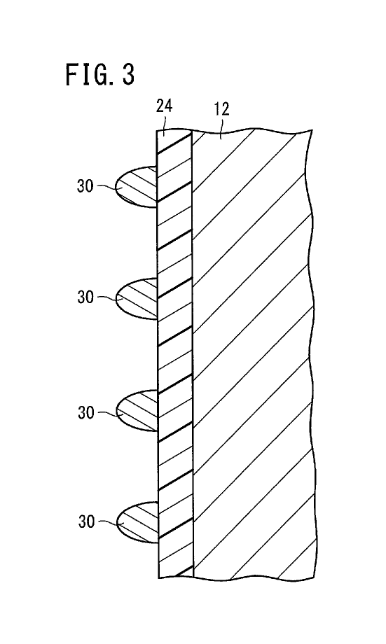

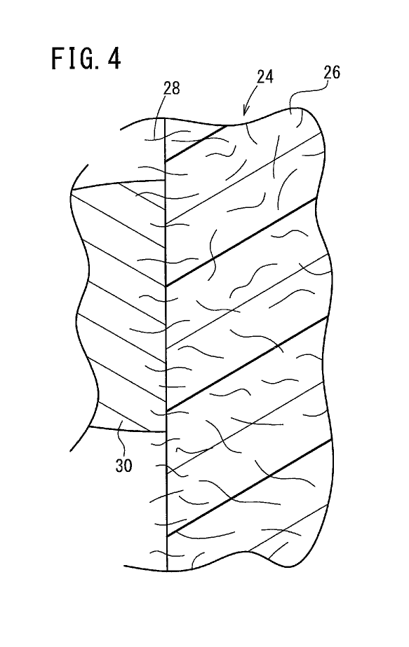

As shown at an enlarged scale in FIGS. 3 and 4, each of the piston skirts 12 has a sliding contact surface formed as a smooth surface, and a base layer 24 that is fixed to the smooth sliding contact surface. The base layer 24 covers the entirety of the sliding contact surface of each of the piston skirts 12 and has a substantially uniform thickness.

The base layer 24 contains a heat resistant resin material 26, which increases the bonding strength between solid lubricators 30, to be described below, and the piston skirts 12. Preferred examples of the resin material 26 include polyimide resin, polyamide-imide resin, epoxy resin, nylon-6 resin, and nylon-6,6 resin, etc.

The base layer 24 also contains fibrous fillers 28 in the resin material 26. The fibrous fillers 28 are in the form of metal fibers, the lengths of which lie within a range from several tens to several hundreds μm, for example, and have ends that project from the surface of the base layer 24. A specific example of the metal fibers is Fe whiskers, although fibers of Fe—Ni—Cr alloy or fibers of tin (Sn) may be used. Alternatively, for example, the fibrous fillers 28 may be in the form of ceramic fibers made of silicon carbide (SiC) or the like, carbon nanotubes, or fibrous graphite.

Assuming that the weight of the resin material 26 is given as 100% by weight, the proportion of the fibrous fillers 28 preferably lies within a range from 10% to 65% by weight. The proportion of the fibrous fillers 28, which is 10% or greater by weight, allows the fibrous fillers 28 to be embedded suitably in the base layer 24 and the solid lubricators 30, thereby making it possible to sufficiently increase the bonding strength between the base layer 24 and the solid lubricators 30. The proportion of the fibrous fillers 28, which is 65% or less by weight, is effective to cause the resin material 26 to sufficiently hold the solid lubricators 30 on the piston skirts 12.

Stated otherwise, the fibrous fillers 28, which are contained in the resin material 26 in the above range, make it possible to prevent the solid lubricators 30 from coming off, maintain a lubricant suitably between the inner wall surface of a cylinder and the piston skirts 12, and avoid the occurrence of adhesion between the inner wall surface of the cylinder and the piston skirts 12.

Although the base layer 24 may contain only the resin material 26 and the fibrous fillers 28, additionally, the base layer 24 may include a solid lubricant. The solid lubricant may be of a known nature. Preferred examples of the solid lubricant include molybdenum disulfide (MoS₂), boron nitride (BN), and graphite (C), etc.

The solid lubricators 30, which extend in a linear manner circumferentially around the piston skirts 12, are disposed on the base layer 24 (see FIGS. 1 and 2). Each of the solid lubricators 30 is raised horizontally from the base layer 24. Therefore, each of the linearly shaped solid lubricators 30 is shaped in the form of a ridge.

Ends of the fibrous fillers 28 are embedded in the solid lubricators 30 and project from the base layer 24 in the vicinity of a contact surface, which is held in contact with the base layer 24. In other words, the fibrous fillers 28 are contained in such a manner that the fibrous fillers 28 lie within and extend between the base layer 24 and the solid lubricators 30. Since ends of the fibrous fillers 28 are embedded in the solid lubricators 30 and other ends thereof are embedded in the base layer 24, the fibrous fillers 28 develop an anchoring effect both in the solid lubricators 30 and in the base layer 24. Therefore, the base layer 24 and the solid lubricators 30 are firmly joined to each other. As a result, it is difficult for the solid lubricators 30 to peel off or become separated from the base layer 24.

According to the present embodiment, the solid lubricators 30 are made of any one of silver, silver alloy, copper, and copper alloy. Each of such materials exhibits an excellent lubricating capability when the piston skirts 12 are held in sliding contact with the inner wall surface of a bore in a cylinder block or the inner wall surface of a cylinder sleeve. Preferred examples of silver alloy include Ag—Sn alloy and Ag—Cu alloy. Preferred examples of copper alloy include Cu—Sn alloy, Cu—Zn alloy, and Cu—P alloy, etc.

If the solid lubricators 30 are made of silver or silver alloy, the purity of silver preferably is 60% by weight or greater. If the purity of silver is less than 60% by weight, the thermal conductivity of the solid lubricators 30 is slightly low, and hence the solid lubricators 30 cannot easily form a smooth wearing surface, resulting in a tendency to lessen the ability to reduce the frictional loss (Psf) of the internal combustion engine. More preferably, the purity of silver is 80% by weight or greater.

If the solid lubricators 30 are made of copper or copper alloy, the purity of copper preferably is 70% by weight or greater, for the same reasons as described above, and more preferably, is 80% by weight or greater in particular.

The purity of silver is defined as the “% by weight of silver contained in the solid lubricators 30”. For example, if the solid lubricators 30 are made of silver alloy, the purity of silver is determined as the % by weight of silver contained in the solid lubricators 30. If the solid lubricators 30 are in the form of sintered bodies produced from a paste after being coated with silver particles, the purity of silver is defined as the proportion of the silver particles in the paste. The purity of copper is defined similarly.

It is not required that all of the solid lubricators 30 are made of the same metal. The solid lubricators 30 may be made of different metals, for example, in such a manner that one of the solid lubricators 30 is made of silver, while another of the solid lubricators 30 adjacent thereto is made of copper alloy.

The solid lubricators 30 are not limited to having a particular thickness. However, if the thickness of the solid lubricators 30 is excessively small, the solid lubricators 30 become worn in a relatively short period of time. Conversely, if the thickness of the solid lubricators 30 is excessively large, the solid lubricators 30 become so heavy that a large driving force is required to move the piston 10 back and forth. In order to avoid such problems, the thickness of the solid lubricators 30 preferably lies within a range from 0.5 to 100 μm.

When the internal combustion engine, which is equipped with such a piston 10, is assembled and operated, the solid lubricators 30 essentially are held in sliding contact with the inner wall surface of the cylinder (the inner wall surface of the cylinder bore or the inner wall surface of the cylinder sleeve) with a lubricating oil interposed therebetween. If the solid lubricators 30 are held in sliding contact with the inner wall surface of a sleeve that is made of FC (gray cast iron) or Al, for example, the sum of the thermal conductivity of the solid lubricators 30 and the thermal conductivity of the sleeve of FC or Al is determined to be 350 W/m·K or greater. In addition, the absolute value of the difference between the Young's moduli of the solid lubricators 30 and the sleeve of FC or Al is 10 GPa or greater.

According to an intensive study by the inventors, in this case, the lubricating oil is retained suitably in the small clearance between the sleeve and the piston skirts 12, thereby preventing adhesion from taking place between the sleeve and the piston skirts 12. Therefore, the sleeve and the piston skirts 12 are effectively prevented from suffering from seizure, whereby the frictional loss of the internal combustion engine is significantly reduced.

According to the present embodiment, furthermore, the solid lubricators 30 and the base layer 24 are firmly joined to each other as a result of the fibrous fillers 28 that are interposed therebetween.

Consequently, it is difficult for the solid lubricators 30 to peel off from the base layer 24. Stated otherwise, the solid lubricators 30 are held on the sliding contact surfaces of the piston skirts 12 over a long period of time. Therefore, due to the existence of the solid lubricators 30, the piston 10 can maintain the above-described advantages over a long period of time.

Since it is difficult for the solid lubricators 30 to peel off from the base layer 24, the above advantages are obtained by the action of the solid lubricators 30, even if the piston 10 is moved back and forth intensively in the cylinder. More specifically, the internal combustion engine in which the piston is incorporated remains highly durable, even if the engine is used in cars that travel in severe environments, such as racing cars including Formula 1 type racing cars or the like, for example.

According to the present embodiment, the piston requires only the addition of a plurality of linear solid lubricators 30. The above-described solid lubricant and the resin material 26 are inexpensive and lightweight. Even though the sliding contact surfaces of the piston skirts 12 overall are covered with the base layer 24 having the solid lubricators 30 disposed thereon, the piston 10 is prevented from becoming high in cost or excessively heavy. In other words, the piston 10 is capable of carrying out a sufficient lubricating action, even though the weight of the piston 10 is prevented from increasing.

Even if a sleeve of Al, which tends to experience seizure in comparison with a sleeve of FC, is used in combination with the piston 10, which is made of aluminum alloy, the piston 10 effectively avoids seizure and is capable of significantly reducing frictional loss in the internal combustion engine. Further, if the base layer 24 contains a solid lubricant, the solid lubricant can ensure a lubricating capability.

The base layer 24 and the solid lubricators 30 can be provided on the sliding contact surfaces of the piston skirts 12 in the following manner.

First, the resin material 26, which is to be made into the base layer 24, is prepared and melted. The fibrous fillers 28 are mixed with the melted material. In the resin material 26, the content of the fibrous fillers 28 preferably lies within a range from 10% to 65% by weight. A solid lubricant may also be added to the resin material 26 and the fibrous fillers 28.

Next, the melted material is supplied to the sliding contact surfaces of the piston skirts 12. The melted material may be sprayed onto the sliding contact surfaces of the piston skirts 12, or alternatively, the sliding contact surfaces of the piston skirts 12 may be coated with the melted material. The melted material preferably is applied so that the sliding contact surfaces of the piston skirts 12 are covered entirely with the melted material. It is easier and simpler to cover the sliding contact surfaces of the piston skirts 12 entirely with the melted material. Stated otherwise, rather than selectively coating portions of the sliding contact surfaces of the piston skirts 12 with the melted material, the base layer 24 can be formed with greater ease.

The melted material, which has been supplied as described above, is cooled and solidified in a state in which the contained fibrous fillers 28 project from the surface of the material. In this manner, the base layer 24 is formed on the sliding contact surfaces of the piston skirts 12.

Meanwhile, fine particles of silver, silver alloy, copper, or copper alloy, preferably having an average particle diameter in a range from 1 to 80 nm, and more preferably from 30 to 80 nm, or stated otherwise, nanoparticles of silver, silver alloy, copper, or copper alloy, are dispersed in a dispersion medium in order prepare a paste. Preferred examples of the dispersion medium are polar solvents including aromatic alcohols such as benzylic alcohol, propylene glycol monomethyl ether acetate (PEGMEA), polyethylene glycol monomethacrylate (PEGMA), terpineol, etc. An unsaturated fatty acid ester may be added as a dispersant to such polar solvents.

For forming the solid lubricators 30, the base layer 24 is coated with the paste containing the dispersion medium, using a known coating process such as a screen printing process, a pad printing process, or the like. Thereafter, the paste together with the piston 10 is heated to a temperature preferably within a range from 160° C. to 240° C. The dispersion medium in the paste is volatilized and the nanoparticles are fused together. In other words, the nanoparticles are sintered, thereby producing the solid lubricators 30 in the form of sintered bodies made up of nanoparticles.

The solid lubricators 30 are obtained by coating the base layer 24 with a paste, at a location where the ends of the fibrous fillers 28 project from the surface of the base layer 24. Consequently, the solid lubricators 30 have ends of the fibrous fillers 28 embedded therein, in the vicinity of a contact surface that is held in contact with the base layer 24. Accordingly, the fibrous fillers 28 are contained in such a manner that the fibrous fillers 28 lie within and extend between the base layer 24 and the solid lubricators 30.

As described above, the solid lubricators 30 are obtained by a coating process, such as a screen printing process, a pad printing process, or the like. Since the coating process is carried out after the melted material has been cooled and solidified into the base layer 24, the printing plate is prevented from becoming clogged with the melted material. In other words, the solid lubricators 30 can be obtained in an efficient manner.

If the solid lubricators 30 are formed from nanoparticles, the solid lubricators 30 are sintered in a relatively low temperature range from 160° C. to 240° C., thereby producing a coating. Therefore, the piston skirts 12, which are made of an aluminum alloy, are prevented from being heated to a high temperature, and the mechanical strength thereof, etc., is prevented from being adversely affected.

The present invention is not limited to the embodiment described above. Various changes may be made to the embodiment without departing from the scope of the invention.

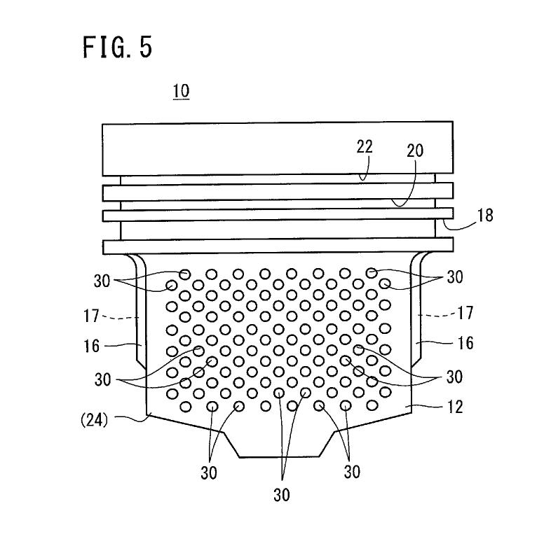

For example, although according to the present embodiment, the solid lubricators 30 are provided in a linear shape, as shown in FIG. 5, the solid lubricators 30 may be provided in a dot shape. Recesses, which are defined between the dot-shaped solid lubricators 30, are effective to fulfill a role of maintaining the lubricating oil.

According to the arrangement shown in FIG. 5, the amount of paste used to form the solid lubricators 30, i.e., the amount of metal (silver, silver alloy, copper, or copper alloy) used, is reduced. Thus, the cost of the piston is further reduced and the weight of the piston 10 is prevented from increasing.

The base layer 24 may be formed selectively only on portions of the piston skirts 12 where the solid lubricators 30 are to be formed. Alternatively, the entire sliding contact surfaces of the piston skirts 12 may be coated with the base layer 24, together with the entirety of the base layer 24 being coated with the solid lubricators 30.

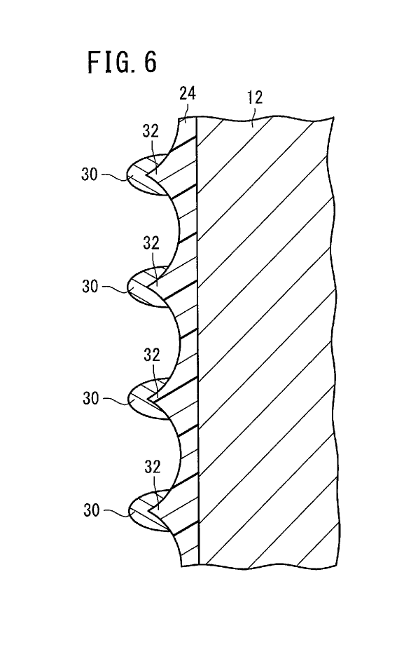

A plurality of linear marks may be provided on the sliding contact surfaces of the piston skirts 12. In addition, the base layer 24 may be provided selectively on the linear marks, whereas the solid lubricators 30 may be provided selectively only on the base layer 24. Alternatively, as shown in FIG. 6, a plurality of protrusive linear ridges 32, which extend around the sliding contact surfaces, may be provided on the base layer 24, and the solid lubricators 30 may be provided in a linear shape or a dot shape on the ridges 32.

In the above embodiment, the base layer 24 is formed by supplying the melted material to the sliding contact surfaces of the piston skirts 12, and then cooling and solidifying the melted material, after which the base layer 24 is coated with the paste in order to form the solid lubricators 30. However, the present invention is not limited to such a process. Alternatively, before the melted material is cooled and solidified, the melted material may be coated with the paste in order to form the solid lubricators 30.

### EXAMPLES

### Inventive Example

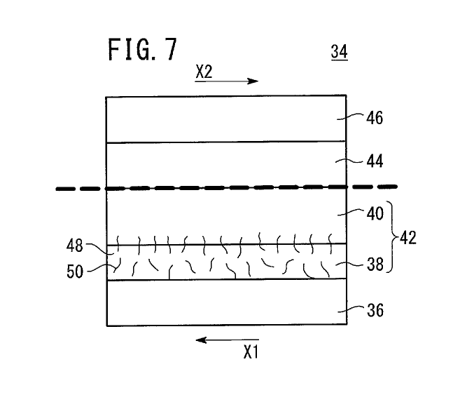

A test piece 34 shown in FIG. 7 was fabricated, and a peel test was conducted on the test piece 34. The test piece 34 had a laminated body 42 made of a base layer 38 and a solid lubricator 40. The laminated body 42 was disposed on the surface of an aluminum alloy sheet 36, which was formed in a sheet-like shape having a length of 25 mm, a depth of 25 mm, and a height of 5 mm. An aluminum alloy sheet 46, which was formed in the same manner as the aluminum alloy sheet 36, was joined to the laminated body 42 by an interposed adhesive 44.

More specifically, a melted material, which was produced by melting a resin material 48 of polyamide imide (PAI), was mixed with fibrous fillers 50 made of iron. At this time, the content of the fibrous fillers 50 in the resin material 48 was 10% by weight.

The surface of the aluminum alloy sheet 36 was treated by shot peening, and thereafter, the surface was coated with the melted material made up of the mixture of the resin material 48 and the fibrous fillers 50, which was supplied by spray coating. Using radiative cooling, the melted material was solidified into the base layer 38.

A paste, which was prepared by dispersing fine particles of silver in benzylic alcohol containing an unsaturated fatty acid ester as a dispersant, was supplied to the base layer 38 by screen printing, after which the entire piece was sintered at 210° C. for 2 hours. Thus, the laminated body 42, in which the base layer 38 and the solid lubricator 40 were joined together by the fibrous fillers 50, was obtained. The thickness of the base layer 38 was 10 μm, whereas the thickness of the solid lubricator 40 was 9μm.

The solid lubricator 40 of the laminated body 42 was coated with the adhesive 44, and the aluminum alloy sheet 46 was joined thereto, thereby fabricating the test piece 34.

The peel test was conducted by applying forces in the directions of the arrows X1 and X2 in FIG. 7 to the aluminum alloy sheets 36, 46 of the test piece 34, and confirming which one of the layers between the aluminum alloy sheets 36, 46 was peeled off. As a result, as indicated by the broken line in FIG. 7, it was confirmed that peel-off occurred between the solid lubricator 40 and the adhesive 44, whereas the base layer 38 and the solid lubricator 40 remained suitably joined to each other.

### Comparative Example 1

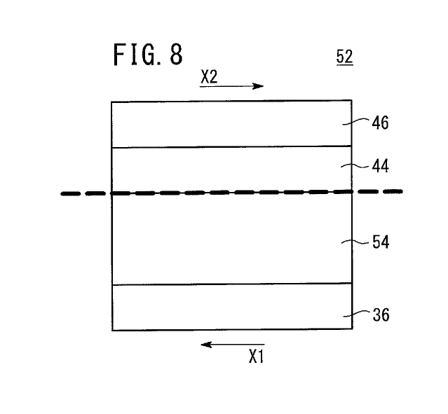

As shown in FIG. 8, a test piece 52 was fabricated, and a peel test was conducted on the test piece 52, in the same manner as the peel test that was performed on the test piece 34. In FIG. 8 and subsequent figures, components which are identical to those shown in FIG. 7 are denoted by identical reference characters, and such features will not be described in detail below.

The test piece 52 included a lubricating layer 54 instead of the laminated body 42 of the test piece 34. In other words, the test piece 52 was fabricated in the same manner as in the Inventive Example, except for the process of fabricating the lubricating layer 54. The lubricating layer 54 was obtained using a melted material, which was produced by melting a resin material of polytetrafluoroethylene (PTFE) and PAI, mixing the melted material with a solid lubricant of MoS₂ and C, supplying the mixed melted material to the aluminum alloy sheet 36 in the same manner as in the Inventive Example, and thereafter sintering the entire piece at 190° C. for 90 minutes. The content of the solid lubricant in the resin material was 10% by weight, and the thickness of the lubricating layer 54 was 22 μm.

A peel test was conducted on the test piece 52. As indicated by the broken line shown in FIG. 8, peel-off occurred between the lubricating layer 54 and the adhesive 44.

### Comparative Example 2

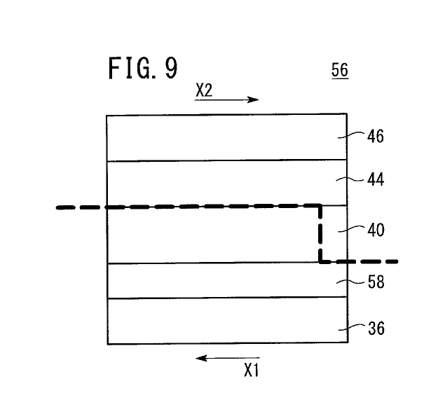

As shown in FIG. 9, a test piece 56 was fabricated, and a peel test was conducted on the test piece 56 in the same manner as the peel test described above. More specifically, shot peening was not performed on the surface of the aluminum alloy sheet 36, and a melted material, which was produced by melting a PAI resin, was supplied to the aluminum alloy sheet 36 by screen printing, thereby producing a base layer 58. Next, a paste of fine particles of silver and a dispersant, which was prepared in the same manner as in the Inventive Example, was supplied to the base layer 58 by screen printing. Thereafter, the test piece 56 was fabricated by the same process used in the Inventive Example. The thickness of the base layer 58 was 3 μm.

A peel test was conducted on the test piece 56. As indicated by the broken line shown in FIG. 9, peel-off occurred between the base layer 58 and the solid lubricator 40.

### Comparative Example 3

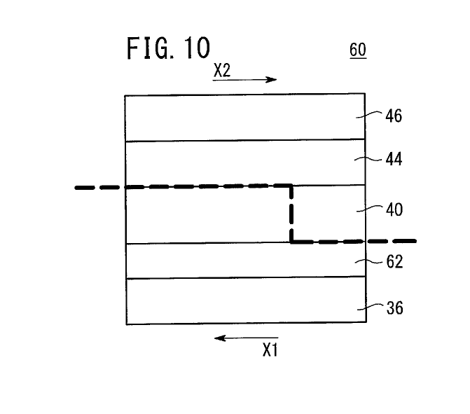

As shown in FIG. 10, a test piece 60 was fabricated, and a peel test was conducted on the test piece 60 in the same manner as the peel test described above. The test piece 60 included a base layer 62 instead of the base layer 38 of the test piece 34. The test piece 60 was fabricated in the same manner as the test piece 34, except for the process of forming the base layer 62. More specifically, in order to form the base layer 62 of the test piece 60, a melted material produced by melting a resin material of PAI was mixed with a solid lubricant of MoS₂ and C, and thereafter, the mixture was supplied to the surface of the aluminum alloy sheet 36, which had been treated by shot peening. The content of the solid lubricant in the resin material was 10% by weight.

A peel test was conducted on the test piece 60. As indicated by the broken line shown in FIG. 10, peel-off occurred between the base layer 62 and the solid lubricator 40.

### Comparative Example 4

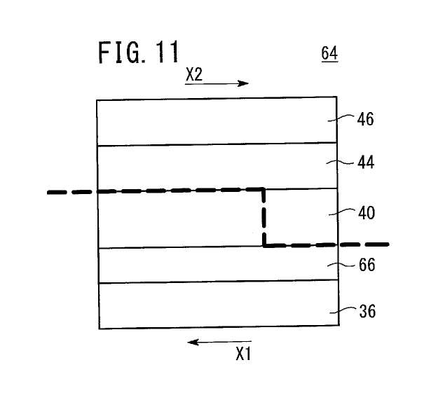

As shown in FIG. 11, a test piece 64 was fabricated, and a peel test was conducted on the test piece 64 in the same manner as the peel test described above. The test piece 64 included a base layer 66 instead of the base layer 38 of the test piece 34. The test piece 64 was fabricated in the same manner as the test piece 34, except for the process of forming the base layer 66. More specifically, in order to form the base layer 66 of the test piece 64, a melted material produced by melting a resin material of PAI was mixed with a solid lubricant of C, and thereafter, the mixture was supplied to the surface of the aluminum alloy sheet 36, which had been treated by shot peening. The content of the solid lubricant in the resin material was 10% by weight.

A peel test was conducted on the test piece 64. As indicated by the broken line shown in FIG. 11, peel-off occurred between the base layer 66 and the solid lubricator 40.

In peel tests performed on the Inventive Example and on Comparative Examples 1 through 4, shear strengths upon the occurrence of peel-off were measured. The shear strengths of the Inventive Example and Comparative Examples 2 through 4, which included the base layer and the solid lubricator, were substantially twice the shear strength of Comparative Example 1, which included PTFE but did not include a base layer.

As can be understood from a comparison of FIGS. 8 through 11, Comparative Examples 2 through 4, which are free of fibrous fillers between the base layer and the solid lubricator, exhibited the occurrence of peal-off between the base layer and the solid lubricator, whereas in the Inventive Example, which includes the fibrous fillers 50, the base layer 38 and the solid lubricator 40 remained in a suitably joined condition while exhibiting substantially the same shear strength as in Comparative Examples 2 through 4.

Accordingly, it was confirmed that the bonding strength between the base layer 38 and the solid lubricator 40 is increased by the fibrous fillers 50, which are provided between the base layer 38 and the solid lubricator 40. Such a feature implies that the existence of the fibrous fillers 50 fortifies the bond between the base layer 38 and the solid lubricator 40, so that it is extremely difficult for interlayer peel-off to occur between the base layer 38 and the solid lubricator 40.

From the foregoing description, it is clear that the fibrous fillers 50, which lie within and extend between the base layer 38 and the solid lubricator 40, make it less likely for the solid lubricator to come off from the piston skirts, and as a result, the lubricant can be maintained suitably between the inner wall surface of the cylinder and the piston skirts.

1. A piston for use in an internal combustion engine, which is movable back and forth in a cylinder of the internal combustion engine, comprising:
a base layer disposed on a sliding contact surface of a piston skirt, the base layer containing a resin material;
a solid lubricator disposed on the base layer; and
fibrous fillers that reside within and extend between the base layer and the solid lubricator.

2. The piston according to claim 1, wherein, assuming that a weight of the resin material is given as 100% by weight, the proportion of the fibrous fillers lies within a range from 10% to 65% by weight.

3. The piston according to claim 2, wherein the solid lubricator comprises at least one of silver, silver alloy, copper, or copper alloy.
